(19) United States
(12) Patent Application Publication
(10) Pub. No.: US 2006/0226211 A1
(43) Pub. Date: Oct. 12, 2006

(54) Mixed ratio calculator

(76) Inventor: David J. La Porte, Cranston, RI (US)

Correspondence Address: WOLF GREENFIELD & SACKS, PC, FEDERAL RESERVE PLAZA, 600 ATLANTIC AVENUE, BOSTON, MA, 02210-2206, US

(21) Appl. No.: 11/346,002

(22) Filed: Feb. 2, 2006

Related U.S. Application Data
(60) Provisional application No. 60/650,459, filed on Feb. 7, 2005.

(51) Int. Cl. G06C 27/00

(52) U.S. Cl. 235/114

(57) ABSTRACT

A mix ratio calculator for a container for holding integrally mixed different fluids in a predetermined ratio, in which a series of ratios and indicia indicating different quantities of the fluids are arranged in fixed relation to one another with means for separately inspecting individual combinations of a ratio and an indicia.

### RELATED APPLICATIONS

This application claims priority under 35 U.S.C. § 119(e) to U.S. Provisional Application Ser. No. 60/650459, entitled “Mixed Ratio Calculator,” filed on Feb. 7, 2005, which is herein incorporated by reference in its entirety.

### BACKGROUND OF THE INVENTION

The present invention relates to a calculator designed to indicate the ratio of mixed ingredients that are proper for a particular purpose and for a particular proper usage.

### BRIEF SUMMARY OF THE INVENTION

Two cycle engines generally require a specifically proportioned ratio of gasoline and oil. If the gasoline and oil ratio is incorrect, the motor may be severely damaged or destroyed. Additionally, the manufacturers of these two cycle engines will ordinarily void manufacturer's warranties if incorrect ratios for gas and oil are used. It is common practice to use a portable gasoline container for filling these two cycle engines. These portable gasoline containers vary in size, shape and dimension. Accordingly, filling these containers with a proper ratio of gasoline and oil for use in a particular two cycle engine presents an issue which is complicated when managing a multiple number of two cycle engines. Multiple containers are ordinarily needed. This requirement is not uncommon since there are many occasions in which multiple two cycle engines are operated by one organization or an individual. For example, landscape companies usually have multiple gas containers for a variety of two cycle motor operated equipment including lawn mowers, trimmers, blowers, and other equipment. Since these tools are frequently made by different companies using different designs, the different mixture ratios present a wide array of maintenance problems.

Since two cycle engines are used not only by landscapers for lawn mowers, trimmers and blowers, but also for a wide range of other tools and machinery such as chainsaws, outboard engines, weed trimmers, leaf blowers, snowmobiles, jet ski motors, or ATVs, the need for assuring a particular engine is provided with a proper mix is a significant problem to manage.

Efforts to deal with this problem have been fairly rudimentary. For example, Kam Tech USA of Simi Valley, Calif. offers for sale a product identified as a Ratio Rite. This product is essentially a translucent measuring cup similar to ones found in kitchens with vertical lines indicating how much oil should be added to achieve a desired ratio. Container sizes are also identified. The item is illustrated in U.S. Design Pat. No. D236,314. This particular product, however, has some failings including that it is not inherently associated with a particular two cycle engine and that it provides no means by which the status of the content of the particular container can be identified.

A second product currently available on the market is offered for sale by Nielsen Pumps, LLC of Broken Arrow, Okla. and is sold under the trademark RITE-MIX oil dispensing pump. This is a manual pump in which a tool attaches directly to a gallon-size container of a two cycle engine. A chart is used to identify how many times to press a plunger to achieve a desired mix. This product also fails to assist in identifying the current status of a particular container.

Additionally, both of these products that are currently available are cumbersome to use and to store. In the case of the latter described unit, the cost is fairly significant and does not provide the flexibility of the current invention.

### OBJECTS AND ADVANTAGES OF THE PRESENT INVENTION

The present invention provides an improved mix ratio calculator which is compact, readily associated, and permanently affixed to a particular container and otherwise identifiable with a particular two cycle engine. The present invention also provides a simple system for calculating the ratio and volume of gasoline and oil to be mixed in a particular container for use with a particular two cycle engine.

The present invention also provides a means for identifying whether or not the content of a container, filled or partially filled, is either mixed or unmixed and the ratio of the mixture, if mixed.

In one embodiment of the present invention, the calculator is designed to be tethered to the handle of the portable gasoline container. It is compact in size, with an outer diameter in the order of 3″ and a thickness of in the order of ½″. It is durable and easily read.

The calculator is particularly adapted for measuring the mixture of gasoline and oil ratios, but has applications to specific mixes of two or more ingredients other than oil and gasoline, such as food, paint, pharmaceuticals, insecticides and adhesives. It is also adapted for use in a variety of sizes, for units of measurement over a wide range of possibilities.

While the preferred embodiment primarily illustrated discloses a ratio calculator that may be tethered to a fluid container, the invention also contemplates a ratio calculator integrally associated with a fluid container. In this embodiment the components of the calculator would be formed on or permanently secured to the container.

The current designs are mechanical in nature and is particularly adapted for an outdoor environment. Other embodiments in the form of electrical generated calculators for use in indoor environment are contemplated. Such electrical designs would also have the further feature of the memory storage for storing information about past usages.

Accordingly, the present invention provides a mixed ratio calculator having a series of stacked members including a top member bearing container identifying indicia, a graphic bearing member having arrayed thereon a plurality of ratios indicating the appropriate mix of oil and gasoline for a particular volume. A movable member having windows through which selected ratios of the indicia may be observed, is positioned to rotate the window to different ratios on the graphic bearing member. A support secures the members together.

### BRIEF DESCRIPTION OF THE DRAWINGS

FIG. 1 is a perspective, exploding view of the components of the present invention;

FIG. 2 is a top plan view of the present invention;

FIG. 3 is an exploded side elevational view of the four primary components for the present invention;

### DETAILED DESCRIPTION OF THE INVENTION

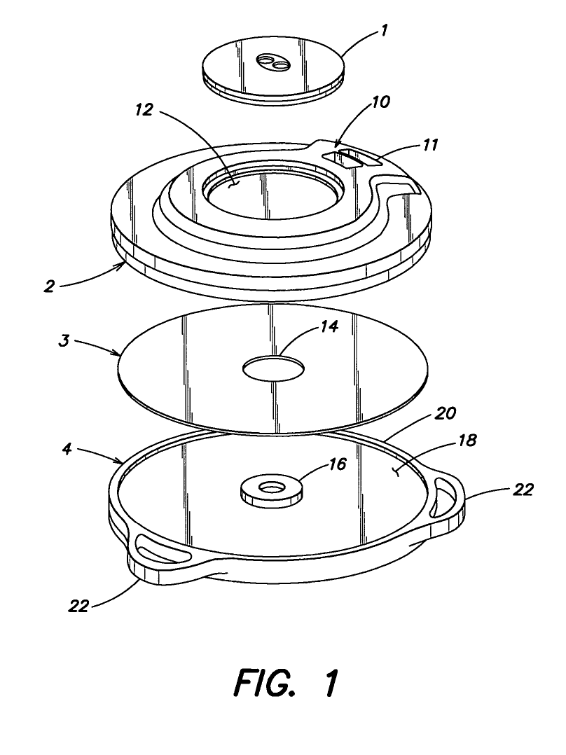

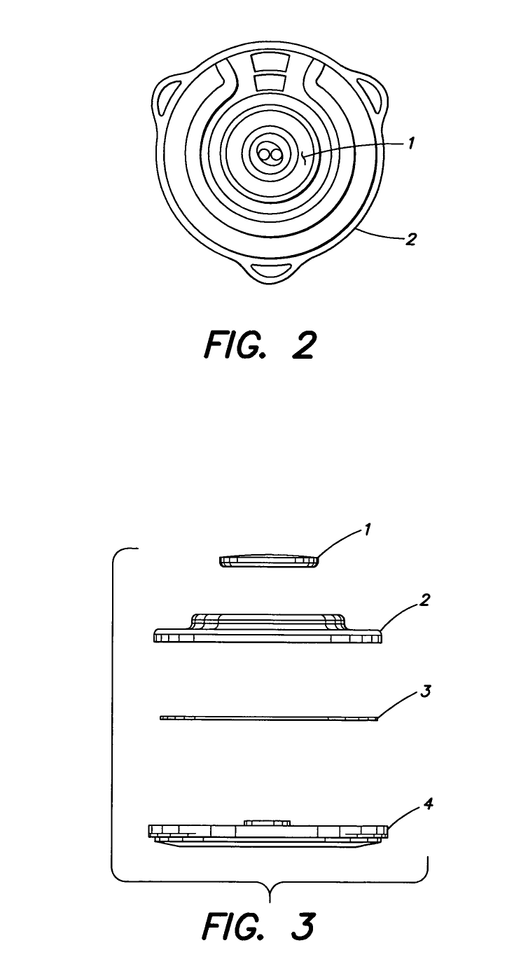

The preferred embodiment shown in FIGS. 1 to 3 of the present invention, when assembled, comprises a sandwich of four primary components including a disc insert 1, a moveable member comprising a top rotating plate 2, a graphic plate 3, and a bottom plate 4. The disc 1 which is coin-like in configuration will bear an indicia indicating the size of the container to which the particular calculator is to be associated or tethered. If it is a one-gallon container, the number 1 or perhaps “1 g” would appear on top of disc 1. If it were a five gallon container, the number 5 or 5 g would appear. Obviously other measures may be provided, as for example in liters.

The graphic plate 3 positioned below the top-rotating plate 2, bears a series of ratio indicia. Preferably there will be multiple ratios radially arranged about and on the upper surface of the graphic plate. Typically fifteen such ratios may be indicated, with each ratio identifying an amount of oil to be added to a defined amount of gasoline for that particular ratio. The ratios will be calculated for the specific equipment for which the calculator is used. For example, the following ratios would be typical for a five-gallon container, with these ratios inserted radially around the center of the graphic plate 3 to indicate the added amount required for each ratio.

| Ratio | Additive Amt. (Oz.) |
|---|---|
| Unmixed | 0 |
| 10:1 | 64 |
| 12:1 | 53 |
| 14:1 | 46 |
| 16:1 | 40 |
| 20:1 | 32 |
| 24:1 | 27 |
| 28:1 | 23 |
| 32.1 | 20 |
| 28:1 | 17 |
| 40:1 | 16 |
| 44:1 | 15 |
| 50:1 | 13 |
| 60:1 | 11 |
| 70:1 | 9 |

The numbers defined as “Ratio” and “Additive Amount” are arranged in concentric rings on the upper surface of graphic plate 3, with the numbers of the “ratio” forming the outer ring of numbers and the numbers of the “additive amount” forming the inner ring. Each member of the ratio and its corresponding member of the additive amount are radially arranged so that two corresponding numbers will be visual through the apertures in the rotating plate 2 when it is rotated to bring the numbers into alignment with apertures in rotating plate 2.

The top rotating plate 2 is provided with a pair of apertures or windows 10, where it is secured in fixed relation to top plate 2 and large enough and oriented specifically to permit observation of a pair of aligned members. Thus, the additive amount numbers will successively show through aperture 11 as plate 2 is rotated. At the same time, the radially corresponding numbers defining the “Ratio” will be successively viewable as a graphic display through aperture 10.

The top rotating plate 2 is also provided with a circular recess 12 shaped to receive the disc 1 in a snap-lock fixed relationship.

Graphic plate 3 fits onto the bottom plate 4 with an axial opening 14 shaped and sized to fit about the upstanding boss 16 formed in the top surface of the bottom plate 4. The graphic plate 3 fits into and is secured within a depression 18 formed by a peripheral rim 20 on the bottom plate 4. A pair of outwardly projecting ears 22 with each ear having an opening therethrough are integrally formed on the periphery of the bottom plate 4.

The calculator will ordinarily be assembled for use with a particular container. In this process, the various components referred to above are assembled by first selecting the disc 1 with a numeral corresponding to the size of the container. If, for example, the container is a one gallon container, the numeral “1” would appear on disc 1. The disc is snapped into the recess 12 where it is secured in fixed relation to top plate 2. The graphic plate 3 is then sandwiched between the rotating plate 2 and bottom plate 4 and snap-locked into the position whereby the top rotating plate may rotate over the graphic plate displaying sequentially the various ratios that are imprinted on the top surface of the graphic plate. The calculator is then secured to a particular container by tethering it by suitable means such as a wire, plastic cable, or other means to the handle of the container, with the container having a size corresponding to the size indicated by the numeral on the disc 1.

The present invention also contemplates a design integrally fixed or associated with a container. In this arrangement, the same components may be resized and shaped to be permanently secured to the outer wall of a container. In one embodiment the components may be arrayed circumferentially about a circular cross section spout with the spout projecting through concentric and aligned apertures coincident with aperture 14. In such an array, the individual units will each have essentially a ring or toroidal shape. If desired, the components may be formed of concentric rings with each having an annular wall parallel to the surface of the spout. In such an arrangement, the plate 2 is provided with the apertures or windows 10 and 11 essentially parallel to the surface of the spout wall. Such an arrangement will allow an indication, not only of the fluids contained therein, but also will indicate if the contents are mixed, what the ratio of the mix is.

In use the operator will have either an empty container, a container holding just gasoline, or a container holding gasoline mixed with oil. When the container is either empty or holding just gasoline, the user would rotate the calculator to the window revealing text reading Unmixed. While adding oil the user would rotate the calculator to the window revealing the desired fluid ratio. The window below the ratio would then reveal the correct amount of oil that should be added. Once the oil has been added the calculator is left in that same position to tell the next user the sate of the container's contents. This cycle might repeat itself as the same container is emptied and used over and over with either different engines or the same engine.

Having now described my invention, I claim:

What is claimed as new and desired to be protected by Letters Patent of the United States is:

1. A mixed ratio calculator associated with a container for holding a plurality of different fluids integrally mixed with one another in a predetermined ratio, comprising a graphic display of a sequence of ratios and a plurality of indicia, each indicating a measured quantity of fluid, with each of the ratios displayed in fixed relation to one of the plurality of indicia, and a moveable member having at least one aperture through which an indicia and a related measured quantity may be commonly visually displayed.

2. A mixed ratio calculator as set forth in claim 1 wherein the ratio calculator is an integral unit having means for tethering the unit to a selected container.

3. A mixed ratio calculator as set forth in claim 2 having means fixed to the calculator for indicating the volume of the container.

4. A mixed ratio calculator as set forth in claim 1 wherein the moveable member is rotating plate relative to the graphic display with at least one aperture therein for sequential viewing of the graphic display.

5. A mixed ratio calculator as set forth in claim 4 wherein the graphic display comprises a flat disc with the indicia on one side thereof, and a bottom plate, with the graphic display positioned between the bottom plate and the moveable member.

6. A mixed ratio calculator as set forth in claim 5 wherein the plurality of indicia are arrayed in a pair of concentric rings with one ring displaying the sequence of ratios and the displaying of the measured quantities of fluid.

7. A mixed ratio calculator as set forth in claim 6 wherein an aperture means in the moveable member, on rotation relative to the graphic display will allow sequential viewing of one of the sequence of ratios and one of the measured quantities of fluid.

8. A mixed ratio calculator as set forth in claim 1 wherein the mixed ratio calculator is permanently secured to a container with the graphic display in fixed relation to the container.

9. A mixed ratio calculator as set forth in claim 1 wherein the moveable member comprises a rotatable plate having a pair of apertures therethrough with the apertures radially aligned with the graphic display.

10. A mixed ratio calculator as set forth in claim 9 wherein the ratios are displayed in a circle and the measured quantities of fluid are displayed in concentric circles to the circle of ratios.
